(19) United States
(12) Patent Application Publication
(10) Pub. No.: US 2010/0126982 A1
(43) Pub. Date: May 27, 2010

(54) Method and an Apparatus for the Supply of a Gas

(75) Inventor: Claes Ingvert, Lund (SE)

Correspondence Address: BUCHANAN, INGERSOLL & ROONEY PC, POST OFFICE BOX 1404, ALEXANDRIA, VA, 22313-1404, US

(73) Assignee: Tetra Laval Holdings & Finance S.A., Pully (CH)

(21) Appl. No.: 11/988,301

(22) PCT Filed: Jun. 2, 2006
(86) PCT No.: PCT/SE2006/000651

§ 371 Date: Jan. 4, 2008

(30) Foreign Application Priority Data
Jul. 4, 2005 (SE) 0501546-6

(51) Int. Cl. H05B 1/02; F24H 9/20; F24H 1/10; B67D 7/80; B65B 57/00

(52) U.S. Cl. 219/494; 392/466; 392/485; 141/4; 141/82

(57) ABSTRACT

The invention relates to a method and an apparatus for the supply of a gas or a gas mixture at a predetermined temperature to a processing station in a filling machine in which gas or gas mixture pressurised to above atmospheric is passed through an electrically heated heating unit (2, 3; 6, 7). This includes a sensor sensing the temperature of the gas whose output signal is fed back to a gas temperature regulator unit (not shown) which in its turn is coupled to the heating unit with a view to regulating the temperature of the gas flowing out from the heating unit (2, 3; 6, 7). The heating unit (7) is formed to an electrically conductive shell or a cavity (6) through which the gas or gas mixture is passed positively and regulated. In such instance, the shell (7) is coupled to a voltage regulated via a regulator unit in an electric current circuit, as a result of the current which is driven by the circuit and as a consequence of the resistance of the material, the shell being heated up and thereby the gas and the gas mixture, whereafter the temperature in the shell is registered and fed back to the regulator unit which regulates the voltage against a gas temperature which corresponds to that which is desired to flow out from the shell or the cavity (6).

### TECHNICAL FIELD

The present invention relates to a method and an apparatus for the supply of a gas or a gas mixture at a predetermined optional temperature and optional flow in any arbitrary application in a filling machine. In the description below, use will be made of the term gas generically also as a designation for any optional gas mixture. In greater detail, the present invention relates to a method and an apparatus in connection with the supply of a gas at a predetermined temperature to a processing station in a filling machine. In the machine, gas pressurised to above atmospheric pressure is passed through an electrically heated heating unit which includes a sensor which senses the temperature of the gas. The output signal from this sensor is fed back to a gas temperature regulator unit which in turn is connected to the heating unit with a view to regulating the temperature of the gas flowing out from the heating unit.

Traditionally, apparatuses of the above-outlined type are based on the employment of heating filaments which are normally enclosed in bodies of ceramics or glass. The gas which it is intended to be supplied is moved positively passed the heating filaments and the enclosure and thus heated there to a suitable temperature. Thereafter, the gas is led via conduits further to one or more nozzles in connection with the pertinent application (see FIG. 1).

### BACKGROUND ART

Typical for such filaments enclosed in ceramic material or glass is that, by being enclosed in the described manner and as a result of their relatively large thermal mass, they have a relatively long heating time, not seldom up towards 30 minutes. Moreover, they are extremely sensitive to variations in the gas flow. However, the temperature of the gas flow which is duly emitted therefrom is most reliably constant, on condition that the flow of the supplied colder gas is constant. Gas flow variations however lead, in the worst case, to the filament or its enclosure being overheated and that the filament or the enclosure are quite simply broken down, with unnecessary and costly operational downtime as a result. In connection with operational downtime of this type, it may moreover be difficult to maintain control over the spread of particles from destroyed elements or filaments. In addition, it is in many cases, depending upon the selected application, desirable to be able to vary both the temperature and the gas flow quite rapidly. In particular in the case when the gas which is desired to be heated does not consist of air, it is desirable occasionally to be able to render the hot gas flow intermittent. For the above-outlined reasons, this is not possible to achieve using a traditional solution. Nor can the generation of hot gas be guaranteed at an acceptably reliable temperature level until perhaps 30 minutes after initiation. What is more, prior art solutions represent the not inconsiderable problem that the heated gas constitutes a major source of severe energy losses of perhaps up towards 300 W/dm² tube surface, in that it is transported in uninsulated tubes to its application site. For natural reasons, this is not desirable, either from the cost viewpoint or against the background of local heating occurring in such cases of areas in a machine where this is not desirable. At the same time, such an undesirable local heating most often entails an undesirable heating of the ambient surroundings of the machine.

Swedish printed Application Number 7104736-9 describes how compressed air under regulated pressure is supplied to a multi-core ceramic heating block. This contains electric heating elements. The current through the elements is controllable in response to signals from a thermocouple which is exposed to the hot air which leaves the ceramic heating block. The signal from the thermocouple is fed back to an electronic temperature regulator. However, the publication in question should most closely be seen as a confirmation of that which is still considered as the state of the art.

### BRIEF SUMMARY OF THE INVENTION

It is thus one major object of the present invention to satisfy, in a novel but above all simple manner, the need for immediate availability of hot gas. The hot gas must be able to be supplied at a predetermined, selected temperature and from a stand-by position be able to be supplied within the course of seconds.

Another object of the present invention is to propose a method of generating hot gas of any type whatever without this per se being dependent on a certain predetermined rate or a certain predetermined pressure of the supplied gas.

One particular object of the method according to the present invention is thereby to be able to realise more rapid and more flexible machine equipment which may immediately and regardless of installation parameters rapidly be regulated in respect of flow and/or temperature. This is probably of particular value in connection with machines in cyclic or intermittent operation.

It is also one object of the present invention to propose an apparatus which may satisfy the need for immediate accessibility despite perhaps intermittent and perhaps wholly irregular operation and moreover compared with prior art apparatuses is extremely simply constructed and thereby displays substantially increased operational reliability compared with prior art apparatuses.

According to the present invention, there is realised a method of the type described by way of introduction by means of which the above-described objects will be attained in that the heating unit is formed into an electrically conductive shell with a cavity defined by the shell through which the gas or gas mixture is passed, the shell being connected to a voltage regulated via a regulator in an electric current circuit, whereby, as a result of the current which is driven by the circuit, principally as a consequence of the resistance of the shell material, the shell is heated and thereby the gas and gas mixture, whereafter the temperature in the shell is registered and recycled to the regulator so that the voltage across or current in the circuit, with the shell as resistance, is regulated against a gas temperature which corresponds to that which is desired flowing out from the shell. In that the gas heater is formed in this manner, there will be obtained a very simple and operationally reliable heater which gives a unit which is as good as insensitive compared with prior art technology in respect of such factors as variations in gas flow. Moreover, the regulation may be put into effect in an extremely elegant manner.

According to a further developed process according to the invention, use is made of the resistance of the electrically conductive material in the shell at each point in time as a measurement magnitude in order to reflect the temperature therein and in order to be fed back to the regulator. Since the resistance in an electrically conductive material is proportional to the temperature of the material, this gives a highly exact measurement, and consequently very exact values are fed back to the regulator.

According to another further developed version of the method according to the invention, the resistance measurement is carried out in the shell material in a region thereof which encompasses one or more outlet apertures. This results in the measured resistance reflecting in a more exact manner the temperature of the gas in connection with the outlet apertures.

According to still another further developed version of the present invention, the shell is formed in a manner adapted in respect of the pertinent practical application. This may be put into effect in that the shell which constitutes the heating unit and which at the inlet side consists of undeformed electrically conductive hoses/tubes is, in the area of the site of application for the generated hot gas through adaptation formation of such a hose element, given a form which closely fits the pertinent application. For example, this formation may be put into effect by vacuum formation. The emission of the hot gas suitably takes place via holes provided in the hose shell which may possibly be specially designed. By such a special design, gas at an extremely accurately controlled temperature can be supplied to the application site which would otherwise be a practical impossibility to achieve, and thereby also the effect of the application of the hot gas will be increased.

According to still another further developed version of the present invention, the inside of the shell is formed with flange-like projections. Hereby, the thermal transfer surface area of the shell is increased, which increases the efficiency of the heating process.

According to yet another further developed version of the present invention, a penetrated of foraminated hose shell is supplied with gas or gas mixture from both of its ends. This entails above all that a larger gas volume can be supplied per unit of time, with the result that the heating stage can no longer be seen as a bottleneck section.

According to still another further developed version of the present invention, the shell is exteriorly thermally insulated. This quite naturally results in a reduction of the unintentional loss of heat volume into the ambient atmosphere, which is both economically and environmentally positive.

In addition, there will be provided according to the present invention an apparatus for carrying out the method, which comprises a body whose design is adapted to the application of the hot gas, the body being intended to permit gas in dependence of its pressure in relation to atmospheric pressure, to be stored or pass therethrough, the body being produced from an electrically conductive material and, via contact terminals thereon is connected to an electric voltage in such a manner that the body functions as an optional resistance element. A shell body thus designed gives both immediate accessibility to hot gas and also affords the possibility of applying the hot gas in an optimum manner for each practical application.

### BRIEF DESCRIPTION OF THE ACCOMPANYING DRAWINGS

The present invention will now be described in greater detail hereinbelow, with reference to one embodiment shown on the accompanying Drawings. In the accompanying Drawings;

FIG. 1 is a schematic view of the predominant mode of approach of today;

FIGS. 2a and 2b schematically show two embodiments of the principle according to the present invention;

FIG. 3a shows yet a further embodiment of the present invention in the form of a shell-shaped heating unit in perspective; and

FIG. 3b shows the embodiment according to FIG. 3a as a cross section from the line IIIb-IIIb in FIG. 3a with a packaging material sheet in a heating position.

### DETAILED DESCRIPTION OF PREFERRED EMBODIMENT

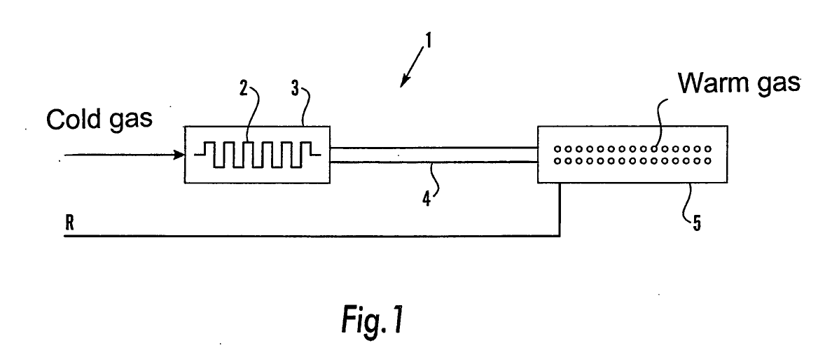

FIG. 1 shows an apparatus 1 which reflects a hitherto applied mode of approach which is employed in order to make possible a powerful temperature elevation of a gas or gas mixture. Cold gas or gas at normal temperature is fed in at the left-hand end of the apparatus 1 shown in the figure to a heating element 2 which comprises one or more filaments surrounded by one or more ceramic elements 3. The ceramics elements 3 are, because they are intended to store and emit a relatively large quantity of energy and because they are thermally insulated, relatively bulky and can, int. al. for this reason, not be placed in association with the site of application for the hot gas. Consequently, the heated gas is led into conduits 4 in order to be conveyed out to these positions where the nozzles 5 are disposed. In or at the nozzles 5, temperature sensors (not shown) are connected in whose signals are fed back to a regulator unit R.

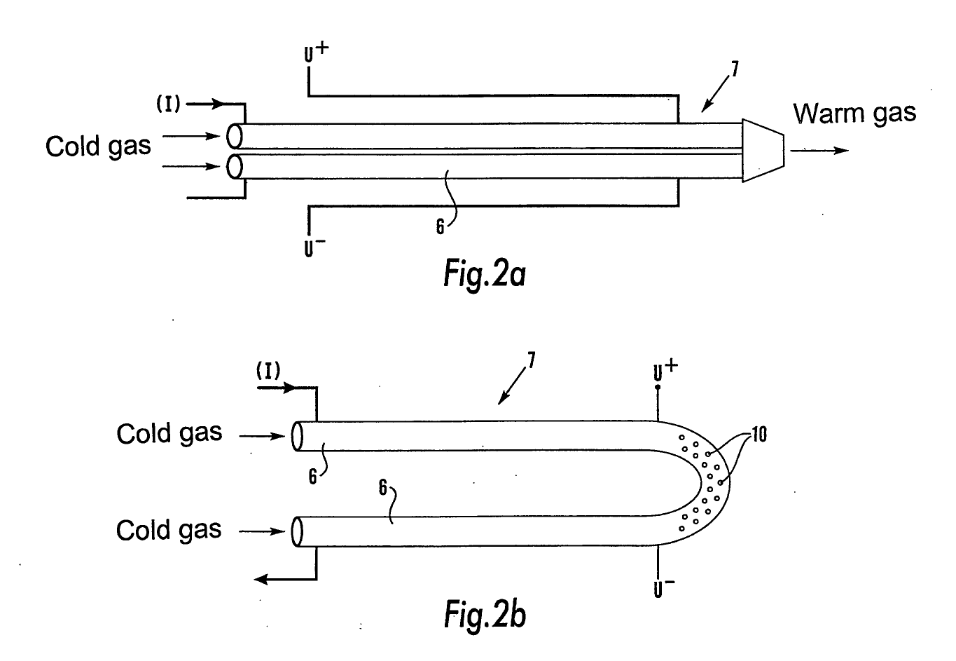

FIG. 2a shows an apparatus 7 for realising the mode of approach according to the present invention. Cold gas, or gas at normal temperature under regulated pressure is fed according to this embodiment into two parallel electrically conductive and short-circuited tubes 6. The tubes 6 are energised so that at current 1 flows through them. In that they are conductors, the tubes represent a predetermined electric resistance. Different choices of material and configuration of the tubes 6 give different properties, but it should most closely be considered as self-evident that as high a resistance as possible is desirable as long as limit values in respect of mechanical strength can be guaranteed. The resistance of a material is a temperature-dependent property and is therefore employed as an indication of precisely the relevant temperature. When cold gas is fed in, the tubes are thus cooled and there then occurs a temperature gradient in the material. By adaptation of the material in the tubes, their length and also the supply voltage, it has been possible to ascertain that, if the tubes are fed with a 50 V direct current and tubes are made between 0.5 and 0.8 m in length, a progressively reduced such gradient will occur, which will as good as become zero in a proximal region of the right-hand end of the tubes. In this region, the voltage drop U⁺-U⁻ is measured at a number of different temperatures, and the relationship is also measured in an expediently extremely rapid regulator unit (not shown). The value of the potential difference between these points is fed back to the regulator unit which compares this true value against a desired norm value and regulates the voltage supply to the tubes 6 in response thereto. Those tubes which are employed are preferably manufactured from stainless steel and are corrugated. As a result of the selection of corrugated tubes, there will be obtained both a larger thermal transfer surface area and a current unit which gives rise to turbulence vortices. Both of these properties increase the effectively in the mode of approach according to the invention in that the thermal exchange increases. The tubes 6 are suitably insulated externally by means of a suitable both electrically and thermally insulating material, on the one hand for safety reasons and on the other hand for energy economy.

FIG. 2b shows an apparatus 7 according to the invention in a simplest possible version. The apparatus 7 is constructed from a single, preferably corrugated stainless steel tube 6 which is energised in a corresponding manner to the apparatus according to FIG. 2a. The tube 6 is fed at both of its ends with cold gas or gas at normal temperature under governable pressure. The resistance in the tube 6 is measured in conjunction with apertures 10 which have been made in the circumferential surface of the tube 6. In the previously described manner, the measured resistance is fed back to a rapid regulator unit (not shown) whose purpose is to regulate the supply of voltage to the tube, thus in dependence upon its temperature and the temperature of the gas located therein which is next about to leave the tube via the apertures 10.

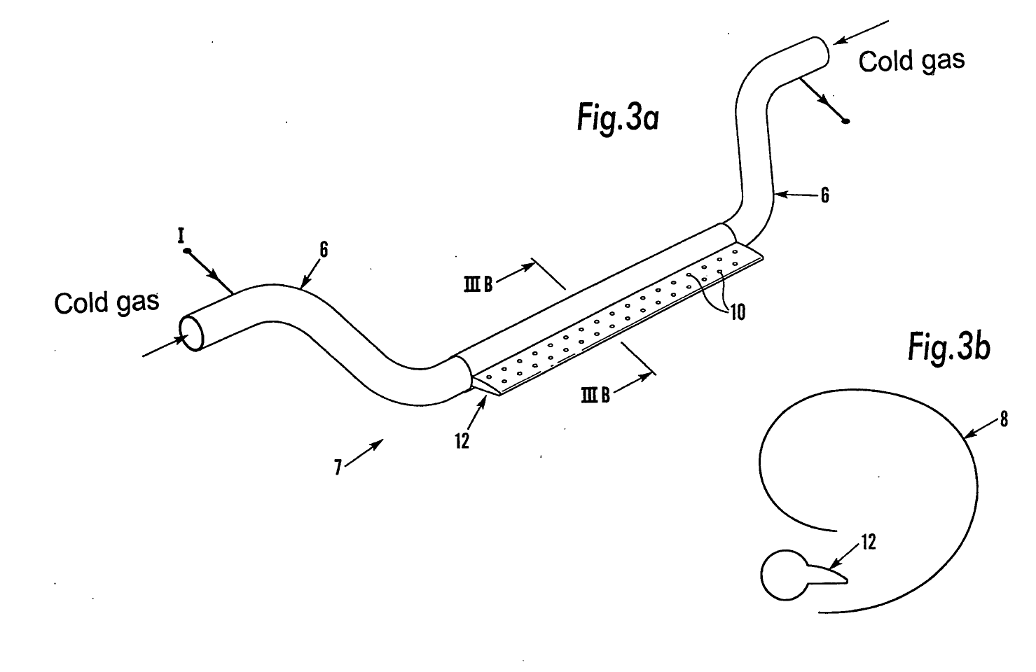

The electrically conducted shell which constitutes the linchpin for all conceivable embodiments of the present invention may be formed in a fundamentally unlimited number of ways depending upon the use of the apparatus. This is illustrated by means of FIGS. 3 and 3b in which a variation of the apparatus is schematically represented. The heating apparatus 7 comprises, in this embodiment substantially a tube 6. Along a part of the length of the tube 6, an elongate gas introduction element 12 provided with gas outlets 10 is fixedly disposed. Said element thereby forms a shell unit together with the tube 6. Cold air which is fed in from both inlet ends of the tube 6 will thus flow out, after heating, through apertures 10 in the gas introduction element.

In that such a simple form as possible, such as a tube with discharge nozzles throttled in a suitable manner can be employed as heating apparatus, possibilities occur such as, for example, dive application where gas is desired to be fed in to different types of formed cavities such as, for example, for sterilisation purposes and associated treatment. It should once again be observed that the apparatus, perhaps principally as a result of its extremely rapid temperature regulation, is insensitive to variations in the flow of the positively supplied gas. The apparatus according to the present invention is, in all its simplicity, robust and reliable in every aspect. The invention should not be considered as restricted exclusively to the embodiments described here, but is restricted only by the scope of the appended Claims.

1. A method in connection with the supply of a gas or gas mixture at predetermined temperature to a processing station in a filling machine in which gas or gas mixture pressurised to above atmospheric is passed through an electrically heated heating unit (2, 3; 6, 7) which includes a sensor sensing the temperature of the gas, whose output signal is fed back to a gas temperature regulator unit (not shown), which in its turn is coupled to the heating unit with a view to regulating the temperature of the gas flowing out from the heating unit (2, 3; 6, 7), characterised in that the heating unit (7) is formed to an electrically conductive shell or a cavity (6) through which the gas or gas mixture is passed, the shell being coupled to a voltage regulated via a regulator unit in an electric current circuit, as a result of the current driven by the circuit and as a consequence of the resistance of the material, the shell being heated up and thereby the gas and gas mixture, whereafter the temperature in the shell is registered and fed back to the regulator unit which regulates the voltage against a gas temperature which corresponds to that which it is desired to flow out from the shell or the cavity (6).

2. The method as claimed in claim 1, characterised in that the resistance at each point in time of the electrically conductive material in the shell (6) is employed as a measurement magnitude to reflect the temperature therein and to be fed back to the regulator unit.

3. The method as claimed in claim 2, characterised in that the resistance measurement in the shell material is carried out in a region of the shell (6) which includes one or more outlet discharge apertures.

4. The method as claimed in claim 3, characterised in that the shell (6) is formed arbitrarily in respect of the practical application of the heated gas or gas mixture.

5. The method as claimed in any of the preceding claims, characterised in that the inside of the shell is formed with fin-like projections.

6. The method as claimed in claim 4 or 5, characterised in that the shell is formed as a vacuum-formed hose which is optionally penetrated or foraminated depending upon its application.

7. The method as claimed in claim 6, characterised in that the penetrated or foraminated hose is supplied with application gas or gas mixture from both of its ends.

8. The method as claimed in any of the preceding claims, characterised in that the shell is thermally insulated exteriorly.

9. An apparatus for supplying a gas or gas mixture at a predetermined temperature to an application site in a filling machine, comprising a unit for infeed of the gas or gas mixture for heating, means (6, 10) in the apparatus (7) on the one hand for raising the temperature of the gas or the gas mixture and, on the other hand (10) for sensing thereof with a view to feeding back the same to a regulator in a temperature regulator unit, and means for emitting the heated gas, characterised in that it includes an optionally formed body (7) which is intended to permit that gas, in dependence of its pressure in relation to atmospheric pressure, is stored in or passed therethrough, said body (7) being produced from an electrically conductive material and, via contacts thereon, being connected to an electric voltage in such a manner that the body functions as an optional resistance element which drives a current through the body (7).

10. The apparatus as claimed in claim 9, characterised in that the body displays means for sensing an expedient parameter in the gas and/or in itself which constitutes an indication of the temperature of the gas or gas mixture volume which is about to leave the body.

11. The apparatus as claimed in claim 10, characterised in that the expedient parameter is the resistance of the body.

12. The apparatus as claimed in claim 11, characterised in that the relevant resistance constitutes the means which, for the regulator unit, indicates the temperature of the gas and which is that magnitude which is continuously fed back to the regulator unit.

13. The apparatus as claimed in claim 12, characterised in that the temperature regulator unit includes an extremely rapid regulator of the “switch mode power controller” type which extremely rapidly regulates the energy which is taken up by the body by regulating the current which flows therethrough.

14. The apparatus as claimed in claim 13, characterised in that those points between which the resistance measurement takes place are located in a region of the shell (7) which encompasses one or more outlet discharge apertures (9).
